(19) United States
(12) Patent Application Publication
(10) Pub. No.: US 2025/0287910 A1
(43) Pub. Date: Sep. 18, 2025

(54) PET KENNEL AND METHOD OF CONSTRUCTION

(71) Applicant: PLUTO OPCO (CAYMAN), LLC, George Town (KY)

(72) Inventors: Mike HARPER, Arlington, TX (US); David VENESS, Fort Worth, TX (US); Ryan PAXSON, Elk Rapids, MI (US)

(21) Appl. No.: 18/607,236

(22) Filed: Mar. 15, 2024

(51) Int. Cl. A01K 1/03; E05C 9/00; E05C 9/08

(52) U.S. Cl. CPC A01K 1/034; E05C 9/006; E05C 9/08

(57) ABSTRACT

A pet kennel and method of construction is disclosed herein. In an embodiment, the pet kennel includes a body and a door assembly. The body has an interior space sized and shaped for a pet. The body also includes a door aperture sized and shaped for entry or exit of the pet into or out of the interior space. The door assembly is attached to the body at the door aperture. The door assembly includes a door having a door lock. The door lock is configured to lock and unlock the door from the body. The door lock includes a handle, a rotating part, and at least one bolt. The handle is configured to cause a rotation of the rotating part that causes the at least one bolt to translate laterally and unlock the door assembly.

### BACKGROUND

### Field of the Invention

The present disclosure relates to a pet kennel and its method of construction. In particular, the present disclosure relates to a pet kennel with improved strength in comparison to prior art pet kennels.

### Background of the Invention

Various conventional pet kennels exist. Conventional pet kennels can include doors that are susceptible to failure or gaps when a user or pet pushes or pulls against the door. Conventional pet kennels can also be susceptible to failure at seams where various parts are attached.

### SUMMARY

The present disclosure provides a durable pet kennel which protects against failure, for example at the door and seams, while maximizing the interior space available for a pet.

In view of the state of the known technology, one aspect of the present disclosure is to provide a pet kennel comprising a body and a door assembly. The body has an interior space sized and shaped for a pet. The body also includes a door aperture sized and shaped for entry or exit of the pet into or out of the interior space. The door assembly is attached to the body at the door aperture. The door assembly includes a door having a door lock. The door lock is configured to lock and unlock the door from the body. The door lock includes a handle, a rotating part, and at least one bolt. The handle is configured to cause a rotation of the rotating part that causes the at least one bolt to translate laterally and unlock the door.

A second aspect of the present disclosure is to provide a pet kennel comprising a body, a frame and a door. The body has an interior space sized and shaped for a pet. The body also includes a door aperture sized and shaped for entry or exit of the pet into or out of the interior space. The frame is attached to the body at the door aperture. The frame includes a strike plate having at least one locking aperture. The door is pivotally attached to the frame. The door includes a door lock configured to lock and unlock the door from the frame. The door lock includes a rotating part and at least one bolt. The rotating part causes the at least one bolt to translate laterally out of the at least one locking aperture to unlock the door.

A third aspect of the present disclosure is to provide a pet kennel comprising a body and a door assembly. The body has an interior space sized and shaped for a pet. The body also includes a door aperture sized and shaped for entry or exit of the pet into or out of the interior space. The door assembly is attached to the body at the door aperture. The door assembly includes a door having a door lock. The door lock is configured to lock and unlock the door from the body. The door lock includes a handle, a rod attached to the handle, a first bolt located at a first end of the rod, and a second bolt located at an opposite second end of the rod. The handle causes the rod to rotate and translate the first bolt and the second bolt laterally to unlock the door.

Also, other objects, features, aspects and advantages of the disclosed pet kennels will become apparent to those skilled in the art in the field of pet kennels from the following detailed description, which, taken in conjunction with the annexed drawings, discloses preferred embodiments of a pet kennel with various features.

### BRIEF DESCRIPTION OF THE DRAWINGS

Referring now to the attached drawings which form a part of this original disclosure:

FIG. 1 illustrates a front perspective view of an example embodiment of a pet kennel in accordance with the present disclosure;

FIG. 2 illustrates a rear perspective view of the pet kennel of FIG. 1;

FIG. 3 illustrates a front view of the pet kennel of FIG. 1;

FIG. 4 illustrates a rear cross-sectional view taken through the center of the pet kennel of FIG. 1;

FIG. 5 illustrates a front exploded view of the door assembly of the pet kennel of FIG. 1;

FIG. 6 illustrates a rear exploded view of the door assembly of the pet kennel of FIG. 1;

FIG. 7 illustrates a front exploded view of the door of the pet kennel of FIG. 1;

FIG. 8 illustrates a front perspective view of the door lock of the pet kennel of FIG. 1;

FIG. 9 illustrates a front exploded view of the door lock of the pet kennel of FIG. 1;

FIG. 10 illustrates a rear perspective view of certain parts of the door lock of the pet kennel of FIG. 1;

FIG. 11 illustrates a rear exploded view of certain parts of the door lock of the pet kennel of FIG. 1; and

FIG. 12 illustrates a front perspective view of the first body portion of the pet kennel of FIG. 1 displayed on a retail shelf.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

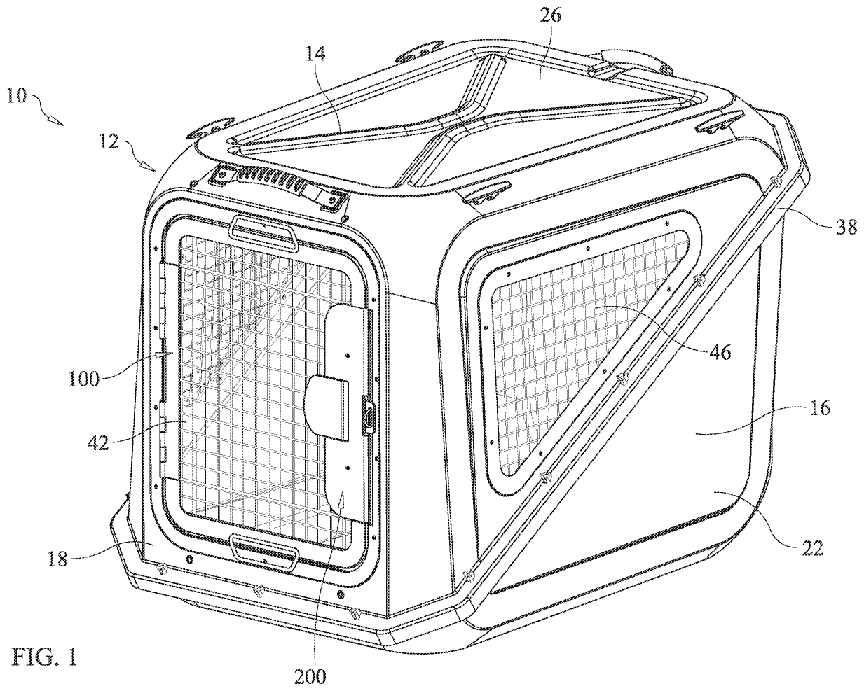

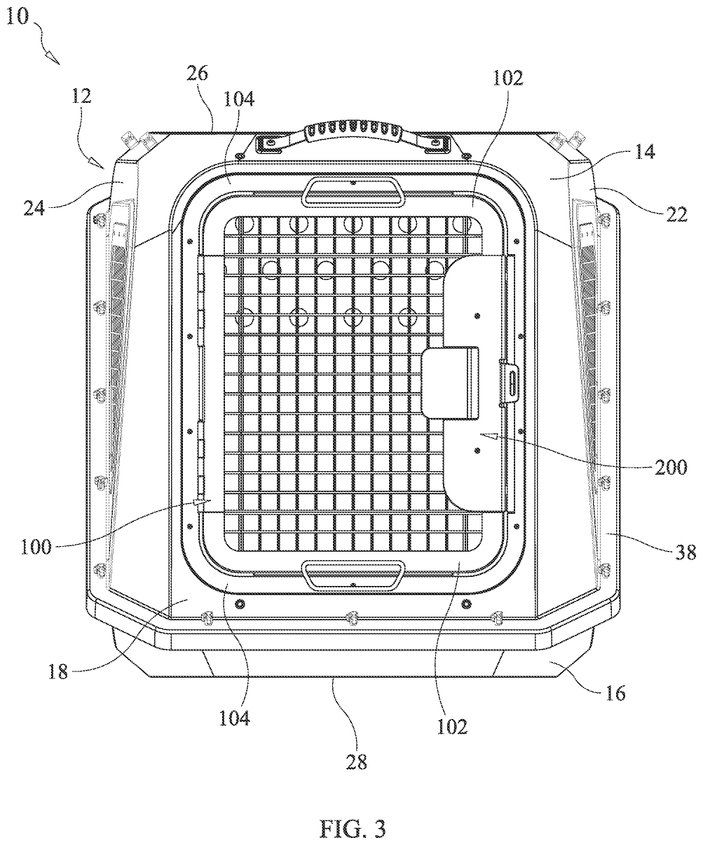

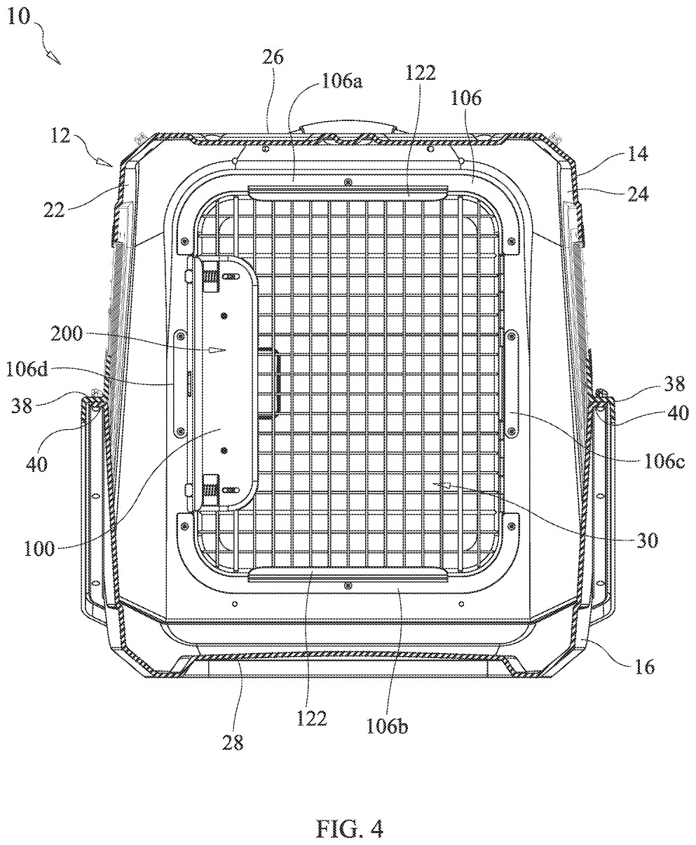

FIGS. 1 to 4 illustrate an example embodiment of a pet kennel 10 in accordance with the present disclosure. In the illustrated embodiment, the pet kennel 10 includes a body 12. The body 12 has a first body portion 14 and a second body portion 16. When the first body portion 14 and the second body portion 16 are attached to each other as shown in FIGS. 1 to 4, the body 12 has a front surface 18, a rear surface 20, a first lateral surface 22 (or left surface 22), a second lateral surface 24 (or right surface 24), a top surface 26 and a bottom surface 28, which enclose an interior space 30 sized and shaped for a pet.

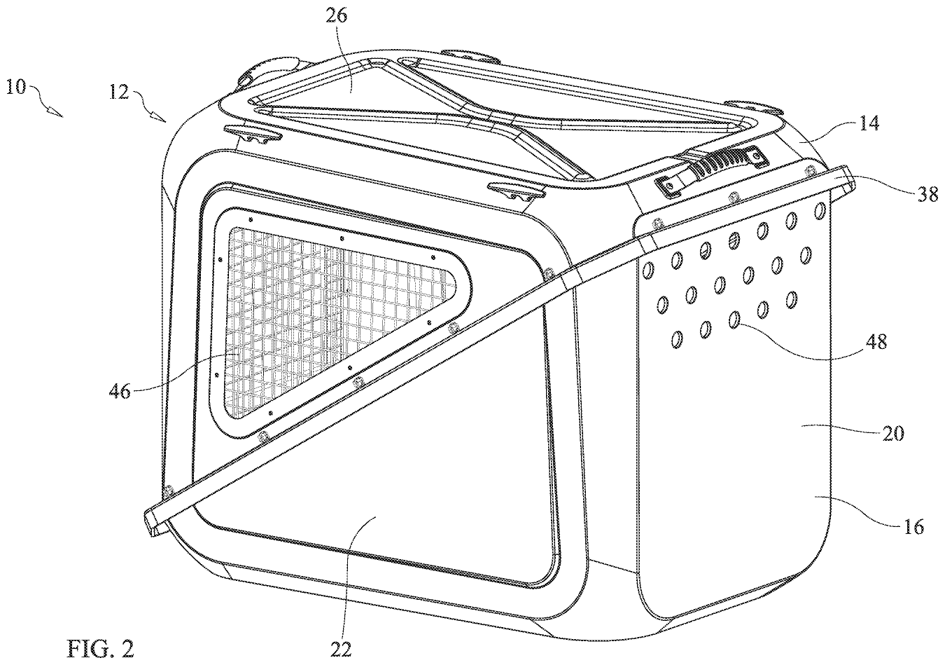

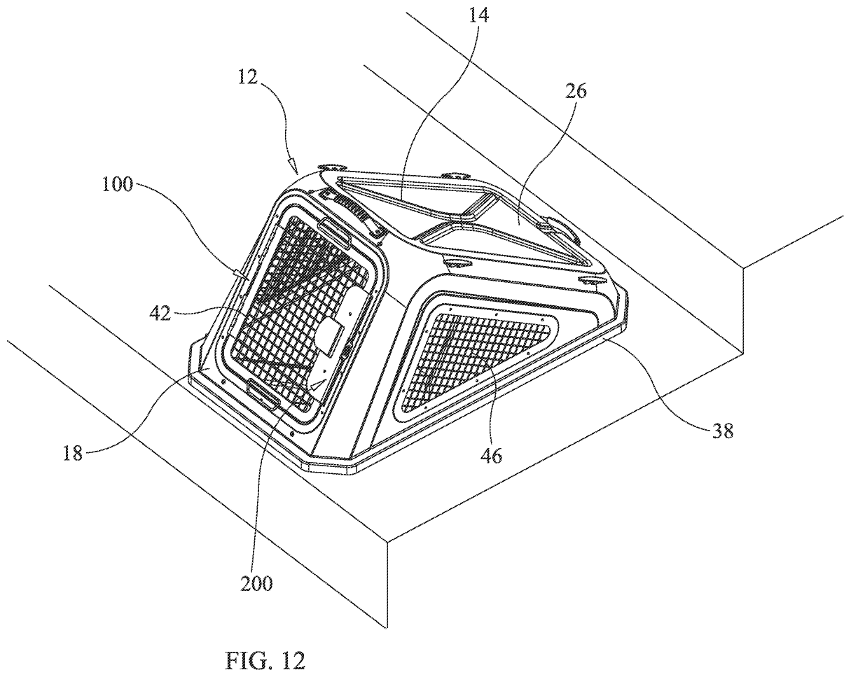

In the illustrated embodiment, the first body portion 14 includes the front surface 18 and the top surface 26 of the body 12. The first body portion 14 also includes a portion of the first lateral surface 22 and a portion of the second lateral surface 24, giving the first body portion 14 a triangular shape from the side as seen in FIGS. 1 and 2. As seen in FIG. 12, this triangular shape is advantageous, for example, for displaying the first body portion 14 at a sale point without the second body portion 16 attached thereto. Similarly, in the illustrated embodiment, the second body portion 16 includes the rear surface 20 and the bottom surface 28 of the body 12. The second body portion 14 also includes a portion of the first lateral surface 22 and a portion of the second lateral surface 24, giving the second body portion 16 a triangular shape from the side as seen in FIGS. 1 and 2. In an alternative embodiment, the first body portion 14 and the second body portion 16 can instead have horizontal borders where they meet. In another alternative embodiment, the first body portion 14 can include all or a portion of the rear surface 20 or bottom surface 28 and/or the second body portion 16 can include all or a portion of the front surface 18 or top surface 26.

The first body portion 14 can be formed as a single piece. The second body portion 16 can also be formed as a single piece. In an embodiment, the first body portion 14 and the second body portion 16 are each formed as a single piece of plastic by known methods, for example, injection molding or other methods. The first body portion 14 and the second body portion 16 can each further include or be formed of a structural foam (e.g., nitrogen or chemical based). By forming certain other parts discussed herein as metal, the first body portion 14 and the second body portion 16 can each be formed of plastic with the pet kennel 10 still passing auto and air safety crash tests. In an alternative embodiment, the first body portion 14 and the second body portion 16 can be formed together as a single piece.

In the illustrated embodiment, the first body portion 14 includes a first lip 38 which extends around the bottom thereof, and the second body portion 16 includes a second lip 40 which extends around the top thereof. As seen in FIGS. 1 to 4, the first lip 38 and the second lip 40 each extend at an upward angle from the front surface 18 to the rear surface 20, such that the first body portion 14 includes most or all of the front surface 18 and the second body portion 16 includes most or all of the rear surface 20. Those of ordinary skill in the art will recognize from this disclosure that the configuration of the first lip 38 and the second lip 40 can vary. For example, in alternative embodiments, the first lip 38 and the second lip 40 can be angled downwardly from the front surface 18 to the rear surface 20, or the first lip 38 and the second lip 40 can be substantially horizontal.

In the illustrated embodiment, the first lip 38 and the second lip 40 each include a plurality of corresponding apertures which enable attachment of the first body portion 14 to the second body portion 16. The corresponding apertures extend vertically through the first lip 38 and the second lip 40, enabling the first body portion 14 and the second body portion 16 to be attached together by a plurality of attachment mechanisms (e.g., screws) extending through the corresponding apertures of the first lip 38 and the second lip 40.

As seen in FIGS. 1 to 4, the body 12 can includes various apertures configured to allow entry or exit of a pet into or out of the interior space 30 and/or allow air to flow into the interior space 30. The apertures also allow viewing through the body 12 and into the interior space 30. The front surface 18 includes a door aperture 42 that encompasses the majority of the area of the front surface 18. The door aperture 42 is sized and shaped for entry or exit of the pet from the interior space 30. The door aperture 42 and is configured to receive a door assembly 100, which is discussed in more detail below. The body 12 can also include one or more side or rear apertures that allow air flow therethrough. In the illustrated embodiment, a lateral grating 46 is attached to the first body part 14 on each of the first lateral surface 22 and the second lateral surface 24 to enable air to flow into the inner space 30. The lateral grating 46 can be formed of metal. The second body part 16 also includes a plurality of apertures 48 on the rear surface 20 to enable air to flow into the inner space 30.

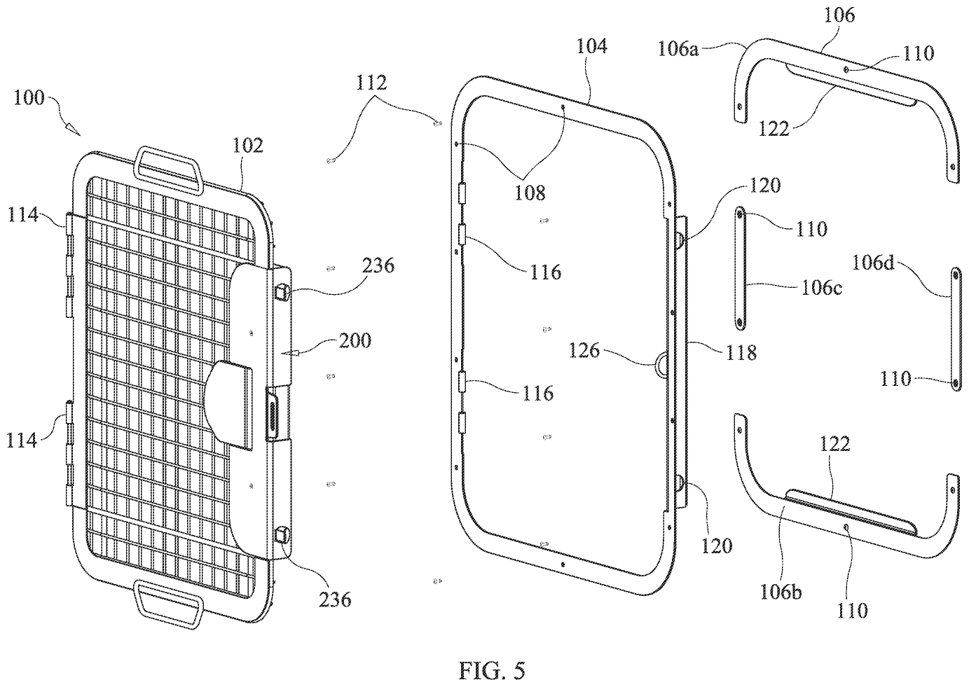

As seen in FIGS. 1 to 4, the pet kennel 10 includes a door assembly 100. The door assembly 100 is configured to be attached to the body 12 at the door aperture 42. FIGS. 5 to 11 illustrate various parts of the door assembly 100 in more detail.

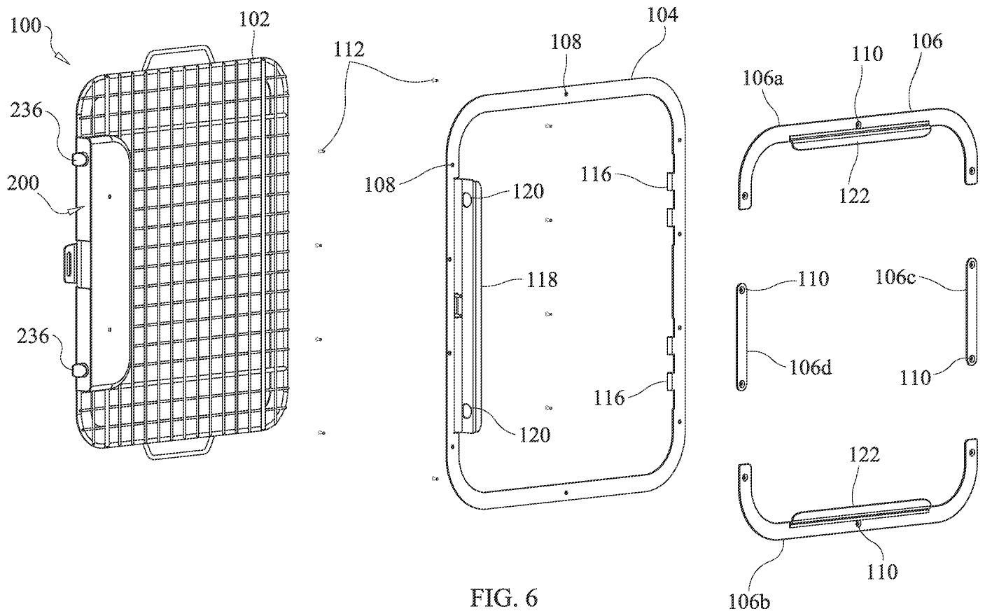

Referring first to FIGS. 5 and 6, an example embodiment of a door assembly 100 is shown. In the illustrated embodiment, the door assembly 100 includes a door 102, an outer frame 104 and an inner frame 106. The outer frame 104 is configured to be secured to the outside of the body 12 around the door aperture 42. The inner frame 106 is similarly configured to be secured to the inside of body 12 around the door aperture 42. The outer frame 104 and the inner frame 106 can each be formed of metal.

In the illustrated embodiment, the outer frame 104 includes a plurality of first apertures 108, and the inner frame 106 includes a plurality of corresponding second apertures 110. The body 12 can also include a plurality of corresponding apertures around the door aperture 42 (not shown). In the illustrated embodiment, both the outer frame 104 and the inner frame 106 are secured around the door aperture 42 by one or more attachment mechanisms 112 (e.g., screws) that extend through the first apertures 108, the body 12, and the second apertures 110.

The outer frame 104 and/or the inner frame 106 can each be formed as a single piece or multiple pieces. For example, in the illustrated embodiment, the outer frame 104 is formed as a single piece, while the inner frame 106 includes a top frame part 106a, a bottom frame part 106b, a first lateral frame part 106c and a second lateral frame part 106d. In an embodiment, the outer frame 104 and/or the inner frame 106 can be omitted. In another embodiment, the door 102 can be attached directly to the body 12.

The door 102 is pivotally attached to the outer frame 104 or the inner frame 106. In the illustrated embodiment, the door 102 is pivotally attached to the outer frame 104. More specifically, the door 102 includes a first hinge part 114, and the outer frame 104 includes a corresponding second hinge part 116. The first hinge part 114 attaches to the second hinge part 116 such that the door 102 is configured to pivot with respect to the outer frame 104. In an alternative embodiment, the inner frame 106 can include the second hinge part 116. In another alternative embodiment, the body 12 can include the second hinge part 116. In the illustrated embodiment, the outer frame 104 further includes one or more strike plate 118 configured to interact with the door 102. The strike plate 118 includes one or more locking apertures 120 that interact with bolts 236 of the door lock 200, as discussed in more detail below. In the illustrated embodiment, the inner frame 106 further includes one or more door stops 122 that prevent the door 102 from pivoting past a particular point of the body 12 and into the inner space 30. In the illustrated embodiment, the outer frame 104 further includes a locking loop 126 that projects through a corresponding locking aperture in the door lock 200, for example, to enable a user to attach an additional padlock.

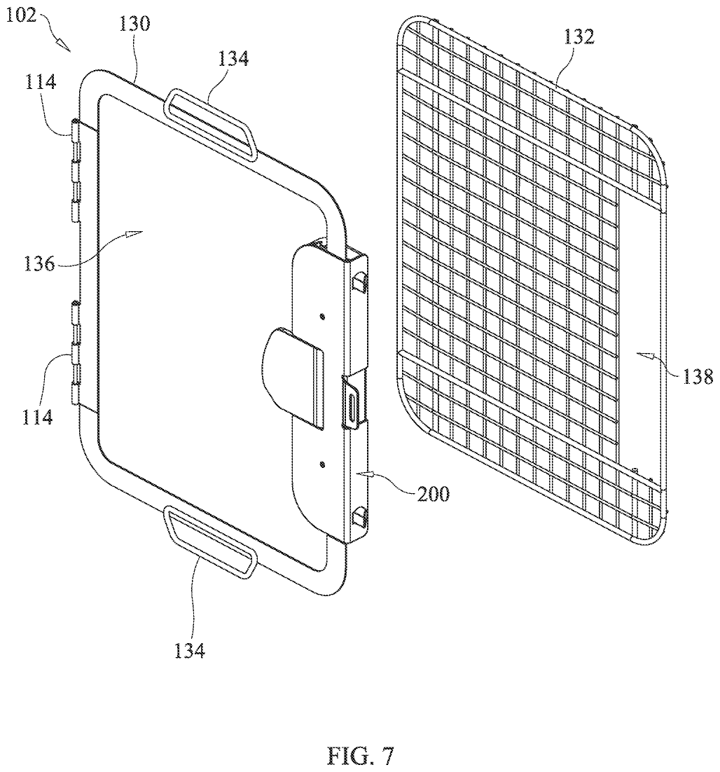

FIG. 7 shows the door 102 in more detail. In the illustrated embodiment, the door 102 includes a door frame 130, a grating 132 and a door lock 200. The door frame 130 includes the first hinge part 114. The door frame 130 also includes one or more door stops 134 that prevent the door 102 from pivoting past a particular point of the body 12 and into the inner space 30. The door frame 130 also includes an aperture 136 that is covered by the grating 132 when the grating 132 is attached to the door frame 130. As seen in FIG. 7, the grating 132 also includes an aperture 138 sized and shaped to receive the door lock 200 when the door 102 is fully assembled.

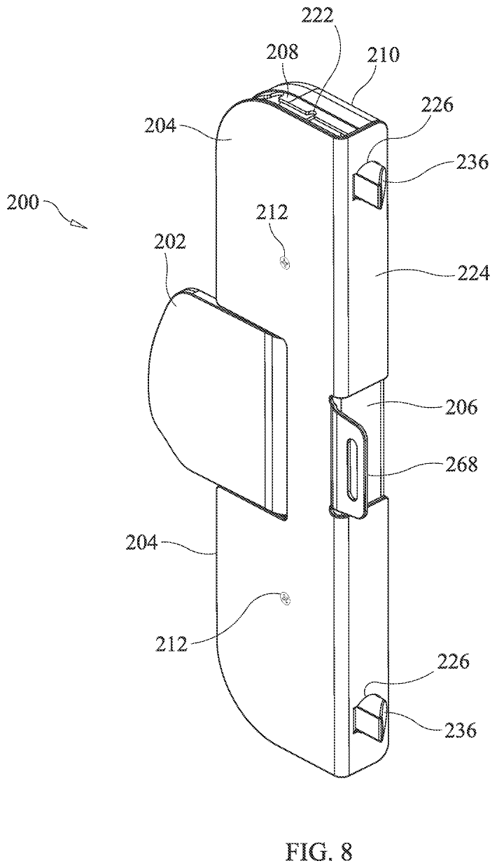

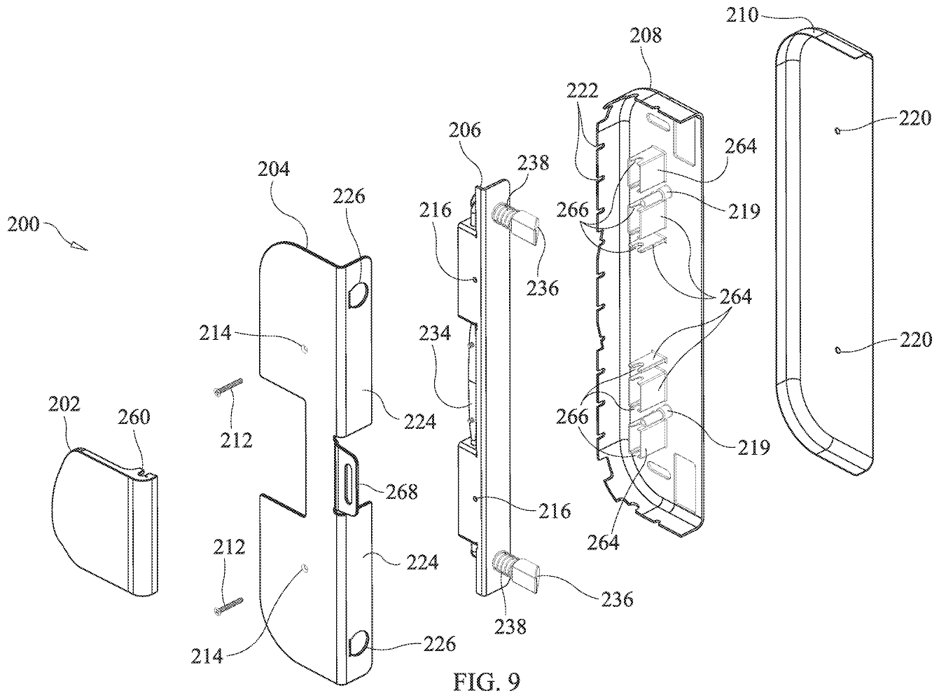

FIGS. 8 and 9 show the door lock 200 in more detail. The door lock 200 is configured to lock and unlock the door from the body 12. In the illustrated embodiment, the door lock 200 includes a handle 202, an outer cover 204, a locking mechanism 206, a support panel 208 and a rear cover 210. As seen in FIG. 9, the outer cover 204, the locking mechanism 206, the support panel 208 and the rear cover 210 attach to each other by one or more attachment mechanisms 212 (e.g., screws) which extend through first apertures 214 in the outer cover 204, second apertures 216 in the locking mechanism 206, third apertures 219 in the support panel 208, and fourth apertures 220 in the rear cover 210. The support panel 208 also includes recesses 222 that receive the grating 132 when the door lock 200 is assembled as shown in FIG. 8. When attached to the grating 132, the grating bars are located in the recesses 222 between the outer cover 204 and the support panel 208. The outer cover 204 also includes one or more faceplate 224 having one or more apertures 226 configured to interact with the locking mechanism 206. The door lock 200 also includes a locking aperture 268 configured to receive the locking loop 126 when the door 102 is closed, for example, to enable a user to attach an additional padlock to the locking loop 126. Those of ordinary skill in the art will recognize from this disclosure that certain portions of the handle 202, the outer cover 204, the locking mechanism 206, the support panel 208 or the rear cover 210 can be combined, separated or moved to another of the handle 202, the outer cover 204, the locking mechanism 206, the support panel 208 or the rear cover 210.

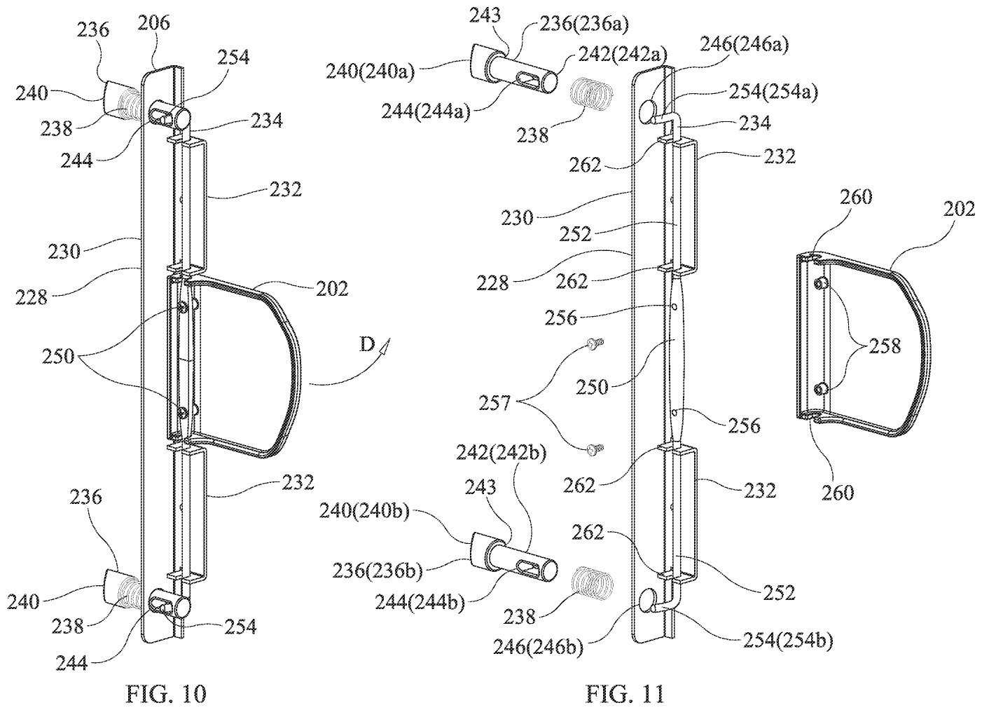

FIGS. 10 and 11 show the locking mechanism 206 in more detail. In the illustrated embodiment, the locking mechanism 206 includes a mounting plate 228, a rotating part 234, one or more bolt 236 and a biasing part 238 (e.g., a spring). The mounting plate 228 includes a main plate 230 and at least one rotating part retainer 232. The handle 202 attaches to the rotating part 234, such that rotation of the handle 202 outwardly from the door lock 200 (in the direction D shown in FIG. 10) and with respect to the mounting plate 228 causes lateral translation of the bolts 236 against the force of the biasing part 238. Likewise, when the handle 202 is released, the biasing force of the biasing part 238 forces the bolts 236 in the opposite lateral direction and pulls the handle 202 back inwardly towards the door lock 200. In the illustrated embodiment, the handle 202 is attached directly to the rotating part 232.

The bolts 236 each include a tip 240 and a shaft 242. The tip 240 is configured to interact with the strike plate 118 of the outer frame 104. More specifically, each tip 240 is configured to protrude through a respective locking aperture 120 in the strike plate 118 to lock the door 102 to the body 12. As seen in FIGS. 8 and 9, the tip 240 is also configured to protrude through a respective aperture 226 in the faceplate 224. In the illustrated embodiment, the diameter of the shaft 242 is smaller than the diameter of the tip 240, enabling the biasing part 238 to bias the bolt 236 outwardly from the faceplate 224 by pressing on the inner ledge 243 where the tip 240 meets the shaft 242. In the illustrated embodiment, each biasing part 238 is a spring that encircles a respective bolt 236 around the shaft 242 and applies a force against the tip 240. In the illustrated embodiment, the bolt 236 is formed as a latchbolt in which the tip 240 has an angled surface that enables the door 102 to close without the user using the handle 202 but requires the user to pull the handle 202 to open the door. In an alternative embodiment, the bolt 236 can be formed as a deadbolt in which the tip 240 has a flat surface.

The illustrated bolt 236 includes an aperture 244 configured to receive the rotating part 234. More specifically, the shaft 242 includes the aperture 244. In the illustrated embodiment, the aperture 244 is longest in the longitudinal direction of the shaft 242 (e.g., horizontal in the Figures). When assembled as shown in FIG. 10, the shaft 242 projects through an aperture 246 in the mounting plate 228, and the biasing part 238 surrounds the shaft 242 and biases the tip away from the mounting plate 228 by applying a biasing force to the ledge 243 formed where the shaft 242 meets the tip 240. The rotating part 234 projects into the aperture 244, so that when the handle 202 rotates the rotating part 234 in the direction D shown in FIG. 10, the rotational force pulls the tip 240 toward the mounting plate 228 against the biasing force of the biasing part 238. When the handle is released, the biasing part 238 biases the tip 240 in the opposite direction away from the mounting plate 228 and causes the rotating part 234 to rotate in the opposite direction.

In the illustrated embodiment, the rotating part 234 is generally shaped as a rod with bent tips (e.g., tips bent at an approximately 90 degree angle with respect to the vertical length of the rod) that protrude into respective apertures 244. The rotating part 234 includes a handle attachment portion 250, one or more retaining portion 252 and one or more projections 254. The handle attachment portion 250 attaches to the handle 202. In the illustrated embodiment, the handle attachment portion 250 includes apertures 256, and the handle 202 attaches to the handle attachment portion 250 via an attachment mechanism 257 (e.g., one or more screws) that extend through the apertures 256 in the handle attachment portion 250 and corresponding apertures 258 in the handle 202. The handle 202 also includes recesses 260 configured to receive the rotating part 234. In the illustrated embodiment, the handle attachment portion 250 is wider than the retaining portions 252 and/or the projections 254 for increased strength at the connection to the handle 202. In the illustrated embodiment, the handle 202 is attached directly to the rotating part 234 at the handle attachment portion 250.

In the illustrated embodiment, the projections 254 are the tips of the rotating part 234 which are bent at an approximately 90 degree angle in comparison to the handle attachment portion 250 and/or the retaining portion 252, enabling the projections 254 to each extend into a corresponding aperture 244 of a respective bolt 236. When constructed as shown in FIG. 10, the projections 254 extend into a respective aperture 244 on one side of the main plate 230, while the tip 240 of each bolt 236 is located on the other side of the main plate 230. Those of ordinary skill in the art will further recognize from this disclosure that the projections 254 can also be located at intermediate portions of the rotating part 234 in addition to and/or instead of the tips 240.

The mounting plate 228 includes one or more rotating part retainer 232. The rotating part retainer 232 is configured to retain the rotating part 234 while the rotating part 234 rotates to cause the door lock 200 to lock and unlock the door 102. In the illustrated embodiment, the rotating part retainer 232 projects from the main plate 230 and is generally perpendicular to the main plate 230. The illustrated rotating part retainers 232 each include one or more recesses 262 configured to receive the rotating part 234. More specifically, the recesses 262 receive a retaining portion 252 of the rotating part 234. As seen in FIG. 9, the support panel 208 also includes corresponding rotating part retainers 264 having recesses 266. When the door lock 200 is fully assembled as shown FIG. 8, the rotating part 234 is located between the recesses 262 and the recesses 266 to keep the rotating part 234 stable and in the correct position while the rotating part 234 rotates.

In the illustrated embodiment, the door lock 200 includes two bolts 236 located at opposite ends of the mounting plate 228 and the rotating part 234. More specifically, the door lock 200 includes a first bolt 236a and a second bolt 236b located at opposite ends of the mounting plate 228 and the rotating part 234. The first bolt 236a includes a first tip 240a and a first shaft 242a, and the second bolt 236b includes a second tip 240b and a second shaft 242b. Each bolt 236a, 236b has a corresponding biasing part 238, is received by a corresponding aperture 226 in the faceplate 224, and is received by a corresponding locking aperture 120 in the strike plate 118. A first projection 254a of the rotating part 234 extends into the aperture 244a of the first bolt 236a, and a second projection 254b of the rotating part 234 extends into the aperture 244b of the second bolt 236b. In the illustrated embodiment, the first projection 254a and the second projection 254b are bent tips at the opposite ends of the rotating part 234 (e.g., rod). The main plate 30 receives the first bolt 236a into a first bolt aperture 246a and receives the second bolt 236b into a second bolt aperture 246b. By including multiple bolts 234 and spacing them in this manner, the door lock 200 has increased stability to protect against failure, for example, when a pet within the inner space 30 pushes on the door 102. Those of ordinary skill in the art will recognize from this disclosure that an alternative embodiment of a pet kennel 10 can also include one bolt 236 or more than two bolts 236. A pet kennel 10 with more than two bolts 236 can be made be increasing the number of projections 254 on the rotating part 234, along with increasing the corresponding apertures 226 in the faceplate 224 and/or locking apertures 120 in the strike plate 118.

When assembled as shown for example in FIG. 1, the door lock 200 is configured to lock and unlock the door assembly 100. The bolts 236 translates into and out of the corresponding locking apertures 120 to lock and unlock the door 102. The door lock 200 unlocks the door assembly 100 when the handle 202 is pulled outwardly from the door assembly 100 to force the bolts 236 out of the locking apertures 120 in the strike plate 118 against the force of the biasing part 238. In other words, the handle 202 causes a rotation of the rotating part 234 that causes the bolts 236 to translate laterally and unlock the door 102. More specifically, the handle 202 causes the rotating part 234 (e.g., rod) to rotate and translate the first bolt 236a and the second bolt 236b laterally to unlock the door 102. The door lock 200 locks the door assembly 100 when the handle 202 is released and the biasing force of the biasing part 238 causes the bolts 236 to project through the locking apertures 120 in the strike plate 118.

Construction of the pet kennel 10 as described herein is also advantageous for displaying the first body portion 14 including the door assembly 100 of the pet kennel 10 at a point-of-sale in a retail environment. More specifically, the first body portion 14 is configured to be detached from the second body portion 16 and displayed on a retail shelf with the door assembly 100 attached to the door aperture 42, so that a customer can view and operate the door assembly 100 from the retail shelf without the second body portion 16 attached.

FIG. 12 illustrates an example embodiment of the first body portion 14 of the pet kennel 10 displayed on a retail shelf. As illustrated, the construction of the pet kennel 10 as described herein enables the first body portion 14 and the second body portion 16 to be separated at the first lip 38 and the second lip 40 for retail display. Once separated, the first body portion 14 can be displayed on the retail shelf with the first lip 38 resting on the retail shelf, and with the second body portion 16 hidden from view. With the embodiment shown, multiple first body portions 14 can be stacked on top of each other on a retail shelf to conserve space. When the first lip 38 and the second lip 40 are angled as shown in the illustrated embodiment of the pet kennel 10, the displayed first body portion 14 has a triangular shape for stacking. Since the illustrated embodiment of the first body portion 14 includes a front-facing door assembly 100 and a front-facing door lock 200, the door assembly 100 and the door lock 200 are both visible and operational from the point-of-sale, and a potential customer can view and/or operate the door assembly 100 and the door lock 200 from the retail shelf without the second body portion 16 attached. Thus, the construction of the pet kennel 10 as described herein enables minimization of retail shelf space while still allowing the customer to view and operate the movable door assembly 100 and door lock 200 of the pet kennel 10.

The embodiments described herein provide improved pet kennels and/or methods for manufacturing and constructing the improved pet kennels. These pet kennels are advantageous, for example, because the illustrated construction improves strength and prevents pets from escaping. It should be understood that various changes and modifications to the pet kennels and corresponding components described herein will be apparent to those skilled in the art and can be made without diminishing the intended advantages.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “section” or “portion” when used in the singular can have the dual meaning of a single part or a plurality of parts.

The term “configured” as used herein to describe a component, section or part of a device that is constructed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed:

1. A pet kennel comprising:
a body having an interior space sized and shaped for a pet, the body further including a door aperture sized and shaped for entry or exit of the pet into or out of the interior space; and
a door assembly attached to the body at the door aperture, the door assembly including a door having a door lock configured to lock and unlock the door from the body, the door lock including a handle, a rotating part, and at least one bolt, the handle configured to cause a rotation of the rotating part that causes the at least one bolt to translate laterally and unlock the door.

2. The pet kennel of claim 1, wherein
the at least one bolt includes a first bolt and a second bolt located at opposite ends of the rotating part.

3. The pet kennel of claim 2, wherein
the first bolt includes a first aperture,
the second bolt includes a second aperture,
the rotating part includes a rod having a first tip and a second tip located at opposite ends,
the first tip extends into the first aperture, and
the second tip extends into the second aperture.

4. The pet kennel of claim 1, wherein
the door assembly includes a frame including a least one locking aperture, and
the at least one bolt translates into and out of the at least one locking aperture to lock and unlock the door.

5. The pet kennel of claim 4, wherein
the door assembly includes an outer frame and an inner frame, and
the outer frame includes a strike plate having the at least one locking aperture.

6. The pet kennel of claim 1, wherein
the door lock includes at least one biasing part configured to bias the at least one bolt into a locked configuration.

7. The pet kennel of claim 6, wherein
the at least one bolt includes a tip and a shaft, and
the biasing part includes a spring that encircles the shaft and applies a biasing force against the tip.

8. The pet kennel of claim 1, wherein
the handle is attached directly to the rotating part.

9. The pet kennel of claim 1, wherein
the door includes a door frame and a grating, and
the grating includes an aperture that receives the door lock.

10. The pet kennel of claim 1, wherein
the body includes a first body portion and a second body portion,
the first body portion includes a first lip and a front surface including the door aperture,
the second body portion includes a second lip and a rear surface,
the first lip and the second lip extend at an upward angle from the front surface to the rear surface, and
the first body portion is configured to be detached from the second body portion and displayed on a retail shelf with the door assembly attached at the door aperture, such that a customer can view and operate the door assembly from the retail shelf without the second body portion attached.

11. A pet kennel comprising:
a body having an interior space sized and shaped for a pet, the body further including a door aperture sized and shaped for entry or exit of the pet into or out of the interior space;
a frame attached to the body at the door aperture, the frame including a strike plate having at least one locking aperture; and
a door pivotally attached to the frame, the door including a door lock configured to lock and unlock the door from the frame, the door lock including a rotating part and at least one bolt, the rotating part causing the at least one bolt to translate laterally out of the at least one locking aperture to unlock the door.

12. The pet kennel of claim 11, wherein
the at least one bolt includes a first bolt having a first aperture and a second bolt having a second aperture,
the rotating part includes a rod having a first tip and a second tip located at opposite ends,
the first tip extends into the first aperture, and
the second tip extends into the second aperture.

13. The pet kennel of claim 11, wherein
the door lock includes a biasing part that biases the at least one bolt toward the at least one locking aperture.

14. The pet kennel of claim 11, wherein
the at least one bolt includes a tip and a shaft, and
the biasing part includes a spring that encircles the shaft and applies a biasing force against the tip.

15. The pet kennel of claim 11, wherein
the door lock includes a mounting plate having a main plate and at least one retainer,
the main plate includes at least one bolt aperture that receives the at least one bolt, and
the at least one retainer is configured to retain the rotating part during rotation.

16. A pet kennel comprising:
a body having an interior space sized and shaped for a pet, the body further including a door aperture sized and shaped for entry or exit of the pet into or out of the interior space; and
a door assembly attached to the body at the door aperture, the door assembly including a door having a door lock configured to lock and unlock the door from the body, the door lock including a handle, a rod attached to the handle, a first bolt located at a first end of the rod, and a second bolt located at an opposite second end of the rod, the handle causing the rod to rotate and translate the first bolt and the second bolt laterally to unlock the door.

17. The pet kennel of claim 16, wherein
the first bolt includes a first tip and a first shaft,
the second bolt includes a second tip and a second shaft, and
the door lock includes a first spring encircling the first shaft and a second spring encircling the second shaft.

18. The pet kennel of claim 16, wherein
the door lock includes a mounting plate having a main plate and at least one retainer,
the main plate includes a first bolt aperture that receives the first bolt and a second bolt aperture that receives the second bolt, and
the at least one retainer is configured to retain the rod during rotation.

19. The pet kennel of claim 18, wherein
the retainer is a first retainer,
the door lock includes a support panel that attaches to the mounting plate,
the support panel includes a second retainer, and
the rod is located between the first retainer and the second retainer.

20. The pet kennel of claim 16, wherein
the rod includes a first bent tip at the first end and a second bent tip at the opposite second end,
the first bent tip protrudes into a first aperture in the first bolt, and
the second bent tip protrudes into a second aperture in the second bolt.
